(19) United States
(12) Patent Application Publication
(10) Pub. No.: US 2025/0086840 A1
(43) Pub. Date: Mar. 13, 2025

(54) IMAGE COMPRESSION AND ASSOCIATED COLOR APPROXIMATION

(71) Applicant: POLAR HPC SOLUTIONS LIMITED, Nicosia (CY)

(72) Inventors: Yurii YURKO, Kriviy Rig (UA); Ihor SHELEVYTSKYI, Kriviy Rig (UA); Sergiy ROKHVARG, Kyiv (UA)

(21) Appl. No.: 18/572,380

(22) PCT Filed: Jun. 25, 2021
(86) PCT No.: PCT/CY2021/000002

§ 371 Date: Dec. 20, 2023

(51) Int. Cl. G06T 9/00; G06T 7/90; G06T 11/00

(52) U.S. Cl. CPC G06T 9/00; G06T 7/90; G06T 11/001; G06T 2207/10024

(57) ABSTRACT

A method includes receiving a digital image with a plurality of color types. wherein the digital image is to be compressed. An approximation function and coefficients associated therewith are received. The approximation function approximates a color value of a one color type of the plurality of color types based on at least two or more other color types of the plurality of color types. The approximation is independent of pixel positions of the digital image. The digital image is compressed by replacing color values of the one color type within the digital image with the approximation function and the selected set of coefficients associated with the one color type. The compressed digital image is transmitted.

### BACKGROUND

With advent of technology and the digital era, such as the Internet and smartphones, the amount of data being transmitted and stored has increased tremendously. The increased data transmission and storage strains computing resources such as available storage and bandwidth for data transmission. As such, various data compression techniques have been introduced. The speed of transmission, storage, and playback of a compressed image for example depend on the compression rate of the input image and the preservation of the desired quality of the original input image.

In one conventional compression methodology, an information loss compression such as entropy coding/compression may be used while in other conventional compression methodologies, spatial correlation of brightness and color such as spatial approximation by cosine functions or wavelets in JPEG algorithms may be used. Another conventional compression methodology utilizes color approximation based on the brightness of Chroma from luma (CfL). Unfortunately, the entropy compression techniques provide a small degree of compression while the approximation methods in space suffers from significant geometric distortion of images being processed while requiring complex calculations. Furthermore, approximation of color by brightness is unfortunately possible only on separate fragments of images where dependence takes place, e.g., color gradient.

Yet in another conventional system, a table of color palettes may be used where each color is assigned a particular number. Unfortunately, the color palettes require a large table, thereby being relatively ineffective in case of images with many different colors.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following. detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1B depict an example of image compression/decompression in accordance with some embodiments.

FIGS. 2A-2F depict an example of creating a compressed image in accordance with some embodiments.

FIGS. 3A-3D depict image compression/decompression in accordance with some embodiments.

FIG. 4 depicts a flow chart illustrating an example of method flow for compressing/decompressing a digital image in accordance with some embodiments.

FIG. 5 depicts a block diagram depicting an example of computer system suitable for compressing an image in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Accordingly, a need has arisen to provide for high degree of compression while reducing geometric distortion of the images. Furthermore, a need has arisen to provide image compression for images regardless of color dependencies. Moreover, a need has arisen to achieve high degree of compression even for images with many different colors.

A new approach for compressing a digital image is proposed for compression of the digital image(s) from still images or from a video stream. In the proposed digital image compression, values for one color type within the digital image is approximated using an approximation function where its coefficients (also referred to as parameters throughout this application) are determined based on at least two or more other color types. It is appreciated that a color type may be a red, green, and blue (RGB) model, or a YUV model where Y is brightness, and where U and V are color differences, or a Cyan, Magenta, Yellow, and Key (CMYK) model.

As a nonlimiting example, three color types exist in the RGB model—red, green, and blue. In some embodiments, a value of a color type, e.g., value of color blue, in the digital image may be approximated using an approximation function where its coefficients have been derived based on the values of the red and green color types in the digital image. In other words, the green and red color types in the digital image may be processed to determine the coefficients of the approximation function that can be used to approximate the value of color type blue in the digital image. Similarly, a color type such as Y for brightness in the YUV model may be approximated using an approximation function where its coefficients are obtained based on the U and V color differences. In some nonlimiting examples, e.g., the CMYK model, a color type such as Cyan may be approximated using an approximation function where its coefficients are obtained based on at least any two of Magenta, Yellow, or Key.

It is appreciated that in some embodiments, a digital image may be divided into several segments/portions. Each portion may be processed separately and independent of other portions of the digital image. For a nonlimiting example, a first portion of the digital image may be processed, as described above, using one approximation function and a set of coefficients that are determined based on other color types within that portion while another portion of the digital image may be processed, as described above, using the same approximation function or a different approximation function and the same set of coefficients or different ones that are obtained based on other color types within the another portion of the digital image. In other words, each portion of the image may be treated the same using the same approximation function and the same coefficients, or using the same approximation function and different coefficients based on color types in each portion, or using a different approximation function and different coefficients.

It is appreciated that the proposed approach and processing occurs in color space and is independent of pixel positions associated with the digital image. Replacing one color type with an approximation function and its coefficients results in significant compression since every color value associated with that color type can be removed and instead replaced with one approximation function and its coefficients to approximate it when decompressed. It is appreciated that the number of color value of the color type may be quite large (e.g., ⅓ of the total number of values in RGB model) in comparison to an approximation function and its determined coefficients. Moreover, since the transformation and processing is performed on one of the color types and is not in the spatial area with pixel coordinates, spatial distortion associated with conventional methods is reduced. It is further appreciated that the proposed methodology may be used in conjunction with other compression techniques to achieve even a higher degree of compression.

It is further appreciated that the approximation function and its coefficients may be used in order to approximate the value of the color type and to recover the compressed image, i.e. to form an uncompressed image. In some embodiments, the approximation function(s) and its associated coefficients may be stored or transmitted to a receiver for decompressing the compressed image when needed. In some embodiments, the coefficients of the approximation function may be modified for more convenient transmission and/or storage. For a nonlimiting example, one or more of the following operations may be performed on the coefficients, such as quantizing, rounding, scaling, and coding (e.g., presentation of a numerical value as fixed-width bit code with a sign bit for each value, presentation of different number of bits for different number for entropy compression (in Huffman encoding), etc.), to name a few.

In general, a two-dimensional digital image may be M by N pixels. Each pixel may have K colors or color types, e.g., RGB, YUV, CMYK, etc. In an RGB model K=3, in CMYK model K=4, etc. As a result, there are M*N*K color values. In other words, for each pixel at coordinates n,m, the color is:

$${P}_{n , m , k} where n = \overline{1 , N} , \qquad ( 1 )$$

$$m = \overline{1 , M} ,$$

$$and$$

$$k = \overline{1 , K} .$$

If one of the color types is approximated using an approximation function based on the other color types then:

$${P}_{n , m , i} \approx f ( {P}_{n , m , k \neq i} , A ) \qquad ( 2 )$$

$$where$$

$$1 \leq i \leq K .$$

It is appreciated that A is a vector of parameters of dimension J, A=[A₁, A₂, . . . , A_{J}], where the parameters are selected to closely approximate the color values of the color type based on the other color types. It is appreciated that vector A may be coefficients of the approximation function. Parameters of vector A replace N*M color values P_{n,m,i} resulting in a compression of:

$$( N * M * ( K - 1 ) + J ) / ( N * M * K ) = ( K - 1 ) / K + J / ( N * M * K ) . \qquad ( 3 )$$

Thus, approximation of a color value of the ith pixel, at n,m coordinate may be:

$${C}_{n , m , i} = f ( {P}_{n , m , k \neq i} , A ) . \qquad ( 4 )$$

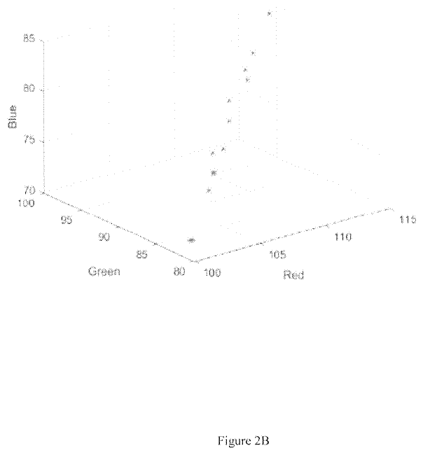

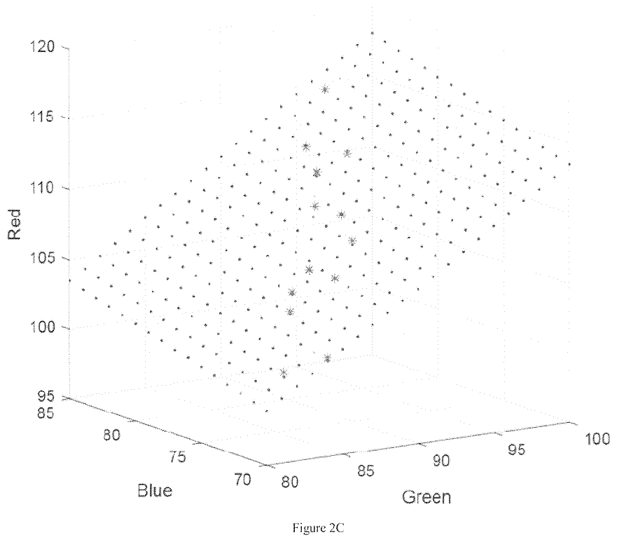

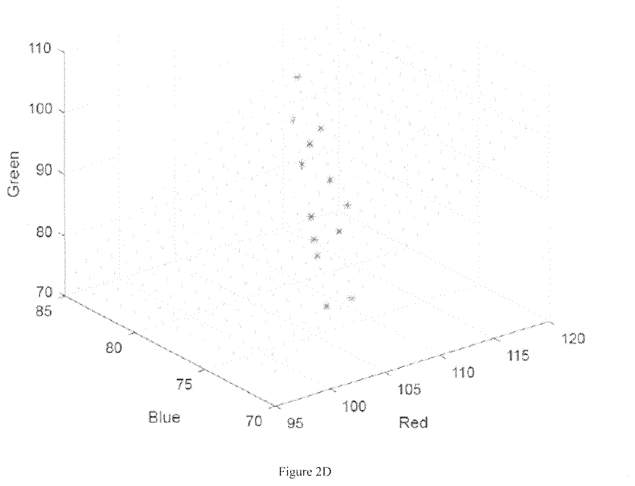

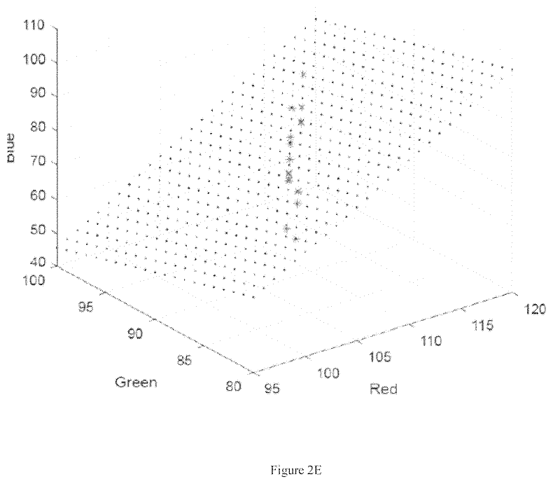

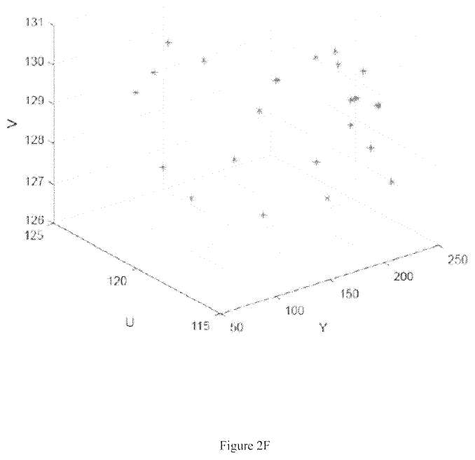

For a rater digital image a certain approximation function may be chosen (discussed in detail later with respect to FIG. 2A). As such, the approximation function with the parameters (also referred to as coefficients) of the approximation function becomes:

$$f ( {P}_{n , m , 1} , {P}_{n , m , 2} , … , {P}_{n , m , K} , {A}_{1} , {A}_{2} , … , {A}_{J} ) . \qquad ( 5 )$$

In equation (5), P_{n,m,1}, P_{n,m,2}, . . . , P_{n,m,K}, is a value of K−1 color types for a pixel with n,m pixel coordinates. Considering equations (1)-(5), the approximation function and its parameters to approximate a value of a color type for various models is described.

In the nonlimiting example of an RGB model, K=3 and each pixel with n,m coordinates has a color value P_{n,m,1} for red, P_{n,m,2} for green, and P_{n,m,3} for blue. It is appreciated that the numbering here is for illustrative purposes and should not be construed as limiting. For a nonlimiting example, in some other embodiments P_{n,m,1} may be for green while P_{n,m,2} might be for blue and P_{n,m,3} might be blue. In some embodiments, one color type, e.g., color red, may be approximated and be a function of the color types blue and green. In other words, a color approximation for color type red, at any pixel location, say n,m is C_{n,m,1}=f(P_{n,m,2}, P_{n,m,3}, A₁, A₂, . . . , A_{J}). It is appreciated that P_{n,m,2} is the color value for color type blue at pixel n,m while P_{n,m,3} is the color value for color type green at pixel n,m. In other words, the color value for the color type red can be estimated using the function with parameters A₁, A₂, . . . , A_{J} that have been derived and computed using the color value for color types green and blue.

Similarly, the color value for color type blue can be estimated as C_{n,m,2}=f(P_{n,m,1}, P_{n,m,3}, A₁′, A₂′, . . . , A_{J}′) and the color value for color type green can be estimated as C_{n,m,3}=f(P_{n,m,2}, P_{n,m,1}, A₁″, A₂″, . . . , A_{J}″). It is appreciated that the parameters for the approximation function may be different for each color type estimation (as shown by vector A, vector A′, and vector A″) or it may be the same.

In the nonlimiting example of an YUV model, Y, U, and V are values of the transformation from the RGB colors, where Y is brightness, and U and B are the color differences. Under this model, instead of the color being approximated, the color transformation is approximated where the transformation includes transformation from RGB color. Under the YUV model, K=3 where one color type (i.e. color transformation in this example) is a function of the other two color types (i.e. also color transformations in this example). In this nonlimiting example, each pixel with n,m coordinates has a color type brightness, and color type differences U and V. The brightness for the color type Y is approximated based on the color differences U and V and it is C_{n,m,1}=f(P_{n,m,2}, P_{n,m,3}, A₁, A₂, . . . , A_{J}). It is appreciated that P_{n,m,2} is the color transformation value for color type U at pixel n,m while P_{n,m,3} is the color transformation value for color type V at pixel n,m. In other words, the color value transformation for the color type Y can be estimated using the function with parameters A₁, A₂, . . . , A_{J} that have been derived and computed using the color transformation values for color types U and V.

Similarly, the color transformation value for color type U can be estimated as C_{n,m,2}=f(P_{n,m,1}, P_{n,m,3}, A₁′, A₂′, . . . , A_{J}′) and the color transformation value for color type V can be estimated as C_{n,m,3}=f(P_{n,m,2}, P_{n,m,1}, A₁″, A₂″, . . . , A_{J}″). It is appreciated that the parameters for the approximation function may be different for each color type estimation (as shown by vector A, vector A′, and vector A″) or it may be the same.

In the nonlimiting example of an CMYK model, K=4 and has a different color system, cyan, magenta, yellow, and key (black) that have different dependencies based on the colors in the RGB model. In this model, each pixel with n,m coordinates has a color value P_{n,m,1} for cyan, P_{n,m,2} for magenta, P_{n,m,3} for yellow, and P_{n,m,4} for key. It is appreciated that the numbering here is for illustrative purposes and should not be construed as limiting. For example, in some other embodiments P_{n,m,1} may be for magenta while P_{n,m,2} might be for key, P_{n,m,3} might be cyan, and P_{n,m,4} for yellow. In some embodiments, one color type, e.g., color cyan, may be approximated and be a function of the color types two or more of magenta, yellow, and key. In other words, a color approximation for color type cyan, at any pixel location, say n,m is C_{n,m,1}=f(P_{n,m,2}, P_{n,m,3}, A₁₁, A₂₁, . . . , A_{J1}) or C_{n,m,1}=f(P_{n,m,2}, P_{n,m,4}, A₁₁₁, A₂₁₁, . . . , A_{J11}) or C_{n,m,1}=f(P_{n,m,4}, P_{n,m,3}, A₁₁₁₁, A₂₁₁₁, . . . , A_{J111}) or C_{n,m,1}=f(P_{n,m,2}, P_{n,m,3}, P_{n,m,4}, A₁₁₁₁₁, A₂₁₁₁₁, . . . , A_{J1111}). It is appreciated that P_{n,m,2} is the color value for color type magenta at pixel n,m while P_{n,m,3} is the color value for color type yellow at pixel n,m and yet P_{n,m,4} is the color value for color type key at pixel n,m. In other words, the color value or transformation thereof for each color type can be estimated using the function with parameters vector(s) that have been derived and computed using the color value types or transformation for color types (i.e. two or more of C, M, Y, and K).

Similarly, the color value for color type magenta can be estimated as C_{n,m,2}=f(P_{n,m,1}, P_{n,m,3}, A₁′, A₂′, . . . , A_{J}′) or C_{n,m,2}=f(P_{n,m,1}, P_{n,m,4}, A₁₁′, A_{21′}, . . . , A_{J1}′) or C_{n,m,2}=f(P_{n,m,4}, P_{n,m,3}, A₁₁₁′, A₂₁₁′, . . . , A_{J11}′) or C_{n,m,2}=f(P_{n,m,1}, P_{n,m,3}, P_{n,m,4}, A₁₁₁₁′, A₂₁₁₁′, . . . , A_{J111}′). Similarly, the color value for color type magenta can be estimated as C_{n,m,3}=f(P_{n,m,1}, P_{n,m,2}, A₁″, A₂″, . . . , A_{J}″) or C_{n,m,3}=f(P_{n,m,1}, P_{n,m,4}, A₁₁″, A₂₁″, . . . , A_{J1}″) or C_{n,m,3}=f(P_{n,m,1}, P_{n,m,3}, A₁₁₁″, A₂₁₁″, . . . , A_{J11}″) or C_{n,m,2}=f(P_{n,m,1}, P_{n,m,2}, P_{n,m,4}, A₁₁₁₁″, A₂₁₁₁″, . . . , A_{J111}″). Similarly, the color value for color type key can be estimated as C_{n,m,4}=f(P_{n,m,1}, P_{n,m,3}, A₁′″, A₂′″, . . . , A_{J}′″) or C_{n,m,4}=f(P_{n,m,1}, P_{n,m,2}, A₁₁′″, A₂₁′″, . . . , A_{J1}′″) or C_{n,m,4}=f(P_{n,m,1}, P_{n,m,3}, A₁₁₁′″, A₂₁₁′″, . . . , A_{J11}′″) or C_{n,m,4}=f(P_{n,m,1}, P_{n,m,3}, P_{n,m,2}, A₁₁₁₁′″, A₂₁₁₁′″, . . . , A_{J111}′″). It is appreciated that the parameters for the approximation function may be different for each color type estimation (as shown by vector A, vector A′, vector A″, and vector A′″) or it may be the same.

It is appreciated that the embodiments are discussed with respect to estimation of one color value of a color type based on two or more color values of other color types. But the embodiments and the discussed processes are equally applicable to a color transformation, as described above.

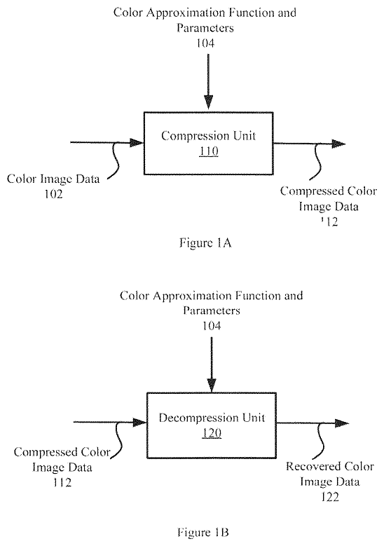

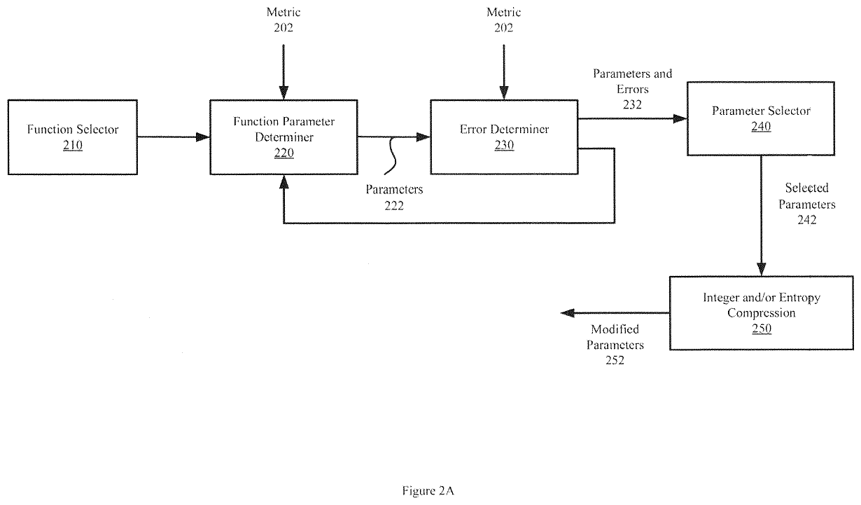

Referring now to FIGS. 1A-1B, an example of image compression and decompression in accordance with some embodiments is shown. Referring specifically to FIG. 1A, a compression unit 110 receives a color image data 102. It is appreciated that the color image data 102 may be a digital image or a portion thereof. The compression unit 110 also receives the color approximation function (also generally referred to as approximation function and discussed in more detail in FIG. 2) along with its parameters 104 (i.e. coefficients, vector A as described above). The approximation function and its parameters 104 replace one color type. The approximation function and its parameters are determined for one color type based on at least two or more other color types of the digital image. For a nonlimiting example, the compression unit 110 may replace all color values of color type blue in an RGB model with the approximation function and its parameters 104 as determined based on color types green and red in the digital image. In other words, the color value for the color type blue in the color image data 102 is removed, hence compressing the image, and replaced with only the approximation function and its parameters 104 to generate the compressed color image data 112. It is appreciated that the compression occurs independent of the pixel positions (i.e. coordinates) of the digital image, thereby reducing and/or eliminating any geometric distortion of the image. It is appreciated that the compressed color image data 112 may be stored or transmitted. Also, it is appreciated that the approximation function and its parameters 104 may be stored for use during decompression of the image.

Referring now specifically to FIG. 1B, a decompression or recovery of the image is illustrated. In this embodiment, the decompression unit 120 receives the compressed color image data 112 (from storage or transmitted as output of the compression unit 110) along with its approximation function and parameters 104. It is appreciated that the approximation function and parameters 104 may be integrated within the compressed color image data 112 where they replace the one color type to be approximated while in other embodiments the approximation function and parameters 104 may be provided separate from the compressed color image data 112 that has at least one less color type than the color image data 102, e.g., because the color blue and its values are removed since they are being approximated by the approximation function and its parameters 104. The decompression unit 120 uses the approximation function and parameters 104 to approximate the one color type and its values to regenerate the color image data 102. However, since the image is being approximated the recovered image data may be slightly different from the color image data 102, hence recovered color image data 122. It is appreciated that since many of the color values of at least one color type are no longer needed, because they are being approximated by an approximation function and its parameters that utilize significantly less data, for transmission or storage, significant resource gains in storage and bandwidth and replay may be achieved.

Referring now to FIG. 2A, an example of creating a compression image in accordance with some embodiments is shown. A function selector component 210 coupled to a function parameter determiner component 220, which is coupled to error determiner component 230, coupled to a parameter selector component 240, which is also coupled to integer and/or entropy compression component 250.

It is appreciated that one embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art. The components discussed above or any portions thereof may be a computing device or be part of a computing device not limited to a server machine, a laptop PC, a desktop PC, a tablet, a Google's Android device, an iPhone, an iPad, and a voice-controlled speaker or controller. Each computing unit has a communication interface (not shown), which enables the computing units to communicate with each other, the user, and other devices over one or more communication networks following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

In some embodiments, the function selector component 210 may be a component that stores various approximation functions for selection thereof. In some embodiments, the approximation function may be user selectable or it may automatically be selected by the system itself. The approximation function may be plane, bilinear, quadratic, cosine, or exponential for K=3, hyperplane for K>3 just to name a few examples. The approximation function may be piecewise functions and splines in some implementations. The approximation function (5), as presented above, may be represented as equation (6) below for plane function where K=3 or for hyperplane function where K>3:

$$f ( {P}_{n , m , 1} , {P}_{n , m , 2} , … , {P}_{n , m , K - 1} , {A}_{1} , {A}_{2} , … , {A}_{K} ) = {A}_{1} * {P}_{n , m , 1} + … + {A}_{K - 1} * {P}_{n , m , K - 1} + {A}_{K} . \qquad ( 6 )$$

It is appreciated that color for a pixel coordinate n,m are independent variables and that there are 2 to K−1 independent variables because one of the colors or color derivative (e.g., transformation) depends on the other or a subset of the other color types. The parameters or coefficients of the approximation function are A₁, A₂, . . . , A_{K}. For plane approximation function where K=3 (e.g., RGB model) equation (6) transforms into equation (7) below:

$$f ( {P}_{n , m , 1} , {P}_{n , m , 2} , {A}_{1} , {A}_{2} , {A}_{3} ) = {A}_{1} * {P}_{n , m , 1} + {A}_{2} * {P}_{n , m , 2} + {A}_{3} . \qquad ( 7 )$$

In comparison, a bilinear approximation function for K=3 (e.g., RGB model or YUV model as an example) may be represented by equation (8) below:

$$f ( {P}_{n , m , 1} , {P}_{n , m , 2} , {A}_{1} , {A}_{2} , {A}_{3} , {A}_{4} ) = {A}_{1} * {P}_{n , m , 1} * {P}_{n , m , 2} + {A}_{2} * {P}_{n , m , 1} + {A}_{3} * {P}_{n , m , 2} + {A}_{4} . \qquad ( 8 )$$

In comparison, a quadratic approximation function for K=3 (e.g., RGB model or YUV model as an example) may be represented by equation (9) below:

$$f ( {P}_{n , m , 1} , {P}_{n , m , 2} , {A}_{1} , {A}_{2} , {A}_{3} , {A}_{4} , {A}_{5} ) = {A}_{1} * {P}_{n , m , 1}^{2} + {A}_{2} * {P}_{n , m , 2}^{2} + {A}_{3} * {P}_{n , m , 1} + {A}_{4} * {P}_{n , m , 2} + {A}_{5} . \qquad ( 9 )$$

In comparison, an exponential approximation function for K=3 (e.g., RGB model or YUV model as an example) may be represented by equation (10) below:

$$f ( {P}_{n , m , 1} , {P}_{n , m , 2} , {A}_{1} , {A}_{2} , {A}_{3} , {A}_{4} , {A}_{5} ) = {A}_{1} * exp ( {A}_{2} * ( {P}_{n , m , 1} - {A}_{3} ) + {A}_{4} * ( {P}_{n , m , 1} - {A}_{5} ) ) . \qquad ( 10 )$$

In comparison, a cosine approximation function for K=3 (e.g., RGB model or YUV model as an example) may be represented by equation (11) below:

$$f ( {P}_{n , m , 1} , {P}_{n , m , 2} , {A}_{1} , {A}_{2} , {A}_{3} , {A}_{4} , {A}_{5} ) = {A}_{1} * cos ( {A}_{2} * ( {P}_{𝔫 , m , 1} - {A}_{3} ) ) * … * cos ( {A}_{4} * ( {P}_{n , m , 1} - {A}_{5} ) ) . \qquad ( 11 )$$

In comparison, a piecewise approximation function and splines may be represented as shown in equation (12) below:

$$f ( {P}_{n , m , 1} , {P}_{n , m , 2} , … , {P}_{n , m , K - 1} , {A}_{1} , {A}_{2} , … , {A}_{W} ) = {\sum }_{j = 1}^{W} {A}_{1} * {B}_{j} ( {P}_{n , m , 1} , … , {P}_{n , m , K - 1} ) , \qquad ( 12 )$$

Where Bᵢ(P_{n,m,1}, . . . , P_{n,m,K-1}) local basis functions are bound to the division grid and where W is the number of grid nodes into which the color space is divided. It is appreciated that a classical polynomial may include a sum of basis functions that are defined over an entire numerical axis from negative infinity to positive infinity. As an example, B₁(x)=1, B₂(x)=x, B₃(x)=x², etc., in an algebraic polynomial or B₁(x)=sin(x), B₂(x)=sin(2x), B₃(x)=sin(3x), etc., in a trigonometric polynomial. In splines, the basis functions take nonzero values only in limited areas, from X₀ to X₁. Outside this fragment, the basis function equals to zero. Accordingly, local basis are advantageous over classical ones in that the increase in the order of the polynomial K is not accompanied by an increase in the complexity of the basis functions. The consequences of increasing order is only a change in the positions of the beginning and the end of nonzero segments. The points that specify the beginning and end of nonzero values of the basis function form a grid on which the spline is built. For example, a simple local basis function is

$${B}_{i} ( x ) = \{ \begin{matrix}i \leq x < i + 1 , & 1 \\ i < x \geq i + 1 , & 0\end{matrix} \} ,$$

where the values form the approximation grid.

It is appreciated that the approximation functions, as described above, with respect to K=3 is for illustrative purposes only and should not be construed as limiting the scope of the embodiments. Once an approximation function is either selected by a user or automatically by the system, it is transmitted to the function parameter determiner 220 where the parameters (i.e. coefficients) of the function is determined. The function parameter determiner 220 also receives metric data 202 where the metric data 202 is a process by which proximity of the estimated color value and the actual color value is evaluated or bounded within a certain accuracy or constraint(s). In some embodiments, the metric data 202 may be norm Lo where the maximum value of the absolute difference between the initial value of the color (actual color value or transformation thereof) and its approximated value as provided by equation (13) below:

$$\begin{matrix}Max \\ n , m\end{matrix} \vert {P}_{n , m , i} - {C}_{n , m , i} \vert where n = \overline{1 , N} , m = \overline{1 , M} , where i = \overline{1 , K} . \qquad ( 13 )$$

Equation (13) illustrates the search for the maximum different between the approximation color and the actual color for all m,n pixels for each color layer. As such, a maximum value for each color is obtained in order to select one with an acceptable error or minimum error (smallest value). It is appreciated that P_{n,m,i} is the actual color value for a color type or a color transformation of a color type whereas C_{n,m,i} is the estimation for that color value or transformation thereof.

In some embodiments, norm L₁ may be used for the metric 202 and provided by equation (14) below:

$${\sum }_{n , m} \vert {P}_{n , m , i} - {C}_{n , m , i} \vert where n = \overline{1 , N} , m = \overline{1 , M} , where i = \overline{1 , K} . \qquad ( 14 )$$

In some embodiments, norm L2 may be used for metric 202 and provided by equation (15) below:

$${\sum }_{n , m} {( {P}_{n , m , i} - {C}_{n , m , i} )}^{2} where n = \overline{1 , N} , m = \overline{1 , M} , where i = \overline{1 , K} . \qquad ( 15 )$$

It is appreciated that the metric 202, as described above, is for illustrative purposes only and should not be construed as limiting the scope of the embodiments. For example, other metric 202 may include but not be limited to peak signal-to-noise ratio (PSNR), structural similarity index measurement (SSIM), mean square error (MSE), etc., that characterize the closeness of the color estimation (or estimation of the color transformation) to the actual color value or actual color transformation. It is appreciated that the metric 202 may be user selectable or automatically selected by the compression system.

It is appreciated that once the approximation function and the metric by which similarity or closeness of the estimation to the actual color value or transformation thereof is determined, then parameters (i.e. coefficients) of the approximation function may be determined. It is, however, appreciated that in some embodiments the closeness may not be necessary and as long as the approximation function is selected then the coefficients of the approximation function may be calculated. It is appreciated that the parameters 222 (i.e. coefficients) of the approximation function may be calculated using a sequential or random search. For a nonlimiting example, in some embodiment, for a given accuracy, the parameters 222 may be discrete limited set of values. In some nonlimiting examples, least square methods (LSM) such as weighted LSM, iterative LSM, generalized LSM, LSM with constraints, etc., can be used. In this illustrative example, the metric 202 of L₂ may be used. In this example, the coefficients may be determined when the condition for equality between P_{n,m,i} and C_{n,m,i} for a certain number of pixels are met and by solving for the linear equations as set out above. In some examples, a gradient method of fastest descent may be used while in other examples method of coordinate descent is used. In some illustrative embodiments one or more machine learning algorithms may be used.

In some embodiments, parameters 222 (i.e. coefficients) of the approximation function are determined and output to the error determiner 230 component in some optional embodiments. In some embodiments, the error determiner 230 component may determine error associated with each set of coefficients for the selected function such that coefficients that result in closest approximation for the selected function can be selected later by the parameter selector 240 component. For example, a first set of coefficients for the approximation function for an RGB model may be determined for color type red based on color types green and blue in a first iteration while a second set of coefficients for the approximation function may be determined for the color type green based on color types red and blue in a second iteration and yet while a third set of coefficients for the approximation function may be determined for the color type blue based on color types red and green in a third iteration. Each set of coefficients may generate a certain error amount that is calculated based on metric 202.

n some embodiments, the parameters (i.e. coefficients) for the approximation function for each color type along with its associated error 232 may be output to the parameter selector 240 to select the parameters (i.e. coefficients). As such, the best set of coefficients for the approximation of a color type may be selected. It is appreciated that selection of one set of coefficients from the set of coefficients by the parameter selector 240 component based on the parameters and errors 232 as determined by the error determiner 230 component is only for illustrative purposes and optional. For a nonlimiting example, in some embodiments, the coefficients for the approximation function for color type blue may be calculated and selected based on color types red and green regardless of the amount of error in its approximation in comparison to coefficients for the approximation function for other color types (i.e. determining the error associated with each set of coefficients and selection of the coefficients is optional).

It is appreciated that in some embodiments, the selected parameter 242 may be output from the parameter selector 240 to the integer and/or entropy compression 250 unit. In this optional illustrative example, the coefficients may be modified to form modified parameters 252 for easier storage and/or transmission. For example, the selected parameters may be quantized, rounded, scaled, coded, etc., as desired. An RGB model example is provided for illustrative purposes.

In some embodiments, an image or a portion of an image may be received by a component to compress the image or by a component to create a compression algorithm (i.e. selecting the approximation function and determining its coefficients). For a nonlimiting example, the image may be a square of 11 by 11 pixels but broken or segmented into portions of 5×5 pixels, where each pixel has three colors associated therewith, hence three color types (i.e. red, green, and blue). The color values for the image that is 5×5 may color type red may be:

$${P}_{n , m , 1} = [ \begin{matrix}109 & 106 & 106 & 109 & 111 \\ 106 & 106 & 105 & 106 & 111 \\ 111 & 111 & 105 & 101 & 106 \\ 115 & 112 & 106 & 104 & 102 \\ 112 & 111 & 111 & 111 & 108\end{matrix} ]$$

The color values for the image that is 5×5 may color type green may be:

$${P}_{n , m , 2} = [ \begin{matrix}77 & 74 & 74 & 79 & 80 \\ 76 & 76 & 75 & 76 & 80 \\ 80 & 80 & 75 & 71 & 74 \\ 84 & 82 & 76 & 74 & 70 \\ 80 & 80 & 80 & 80 & 75\end{matrix} ]$$

The color values for the image that is 5×5 may color type blue may be:

$${P}_{n , m , 3} = [ \begin{matrix}91 & 88 & 88 & 91 & 92 \\ 88 & 88 & 86 & 88 & 92 \\ 92 & 92 & 86 & 82 & 88 \\ 96 & 93 & 88 & 85 & 84 \\ 94 & 92 & 92 & 92 & 90\end{matrix} ]$$

It is appreciated that pixel values arranged in color space without any pixel coordinate information is illustrated in FIG. 2B. For this illustrative example, the selected approximation function is equation (7) and as such the function for color type red may be represented by equation (16) below:

$$r = {a}_{1} * g + {a}_{2} * b + {a}_{3} , \qquad ( 16 )$$

where r is the value for color type red, g is the color value for color type green, b is the color value for color type blue, and a₁, a₂, and a₃are the coefficients of the approximation function as determined based on the metric 202, which in this instance may be least squares as shown by equation (15) above. In other words, the coefficient values a₁, a₂, and a₃ are determined by solving the equation bounded by equation (15). Coefficient values a₁, a₂, and a₃ are determined to be 0.7301, 0.3105, and 18.7356 respectively.

Accordingly, the three determined coefficients replace 25 red color type values in 25 pixels. The compression ratio resulting from this is 1−(50+3)/75=0.2933 as determined through equation (3). Using the determined coefficients for the approximation function and rounding to the integer values to estimate color type red results in

$${C}_{n , m , 1} = [ \begin{matrix}109 & 106 & 106 & 109 & 111 \\ 107 & 107 & 105 & 107 & 111 \\ 111 & 111 & 105 & 101 & 106 \\ 115 & 112 & 107 & 104 & 102 \\ 112 & 111 & 111 & 111 & 108\end{matrix} ] .$$

The difference between P_{n,m,1} and C_{n,m,1} with rounding becomes:

$${P}_{n , m , 1} - {C}_{n , m , 1} = [ \begin{matrix}0 & 0 & 0 & 1 & 0 \\ 1 & 1 & 0 & 1 & 0 \\ 0 & 0 & 0 & 0 & 0 \\ 0 & 0 & 1 & 0 & 0 \\ 1 & 0 & 0 & 0 & 0\end{matrix} ] ,$$

that least square has been used to determine the coefficient values and that L₂ error calculation is used to determine the error. However, use of the same standard for coefficient calculation and error calculation is for illustration purposes and should not be construed as limiting the scope of the embodiments. For example, in some embodiments, even though a least square may be used to determine the coefficient values but nonetheless L₁ error calculation may be used to determine the error. The approximation of color type red in color space is illustrated in FIG. 2C.

It is appreciated that in some embodiments a similar process may be performed for each color type, i.e. color type green and color blue. Color type green may be represented by equation (17) below:

$$g = {a}_{1} * r + {a}_{2} * b + {a}_{3} , \qquad ( 17 )$$

where r is the value for color type red, g is the color value for color type green, b is the color value for color type blue, and a₁, a₂, and a₃ are the coefficients of the approximation function as determined based on the metric 202, which in this instance may be least squares as shown by equation (15) above. In other words, the coefficient values a₁, a₂, and a₃are determined by solving the equation bounded by equation (15). Coefficient values a₁, a₂, and a₃ are determined to be 1.1791, −0.2392, and −19.4228 respectively. Accordingly, the three determined coefficients replace 25 green color type values in 25 pixels. Using the determined coefficients for the approximation function and rounding to the integer values to estimate color type green results in

$${C}_{n , m , 2} = [ \begin{matrix}91 & 88 & 88 & 90 & 92 \\ 87 & 87 & 86 & 87 & 92 \\ 92 & 92 & 86 & 83 & 88 \\ 96 & 93 & 87 & 86 & 84 \\ 94 & 92 & 92 & 92 & 90\end{matrix} ] .$$

The difference between P_{n,m,2} and C_{n,m,2} with rounding becomes:

$${P}_{n , m , 2} - {C}_{n , m , 2} = [ \begin{matrix}0 & 0 & 0 & - 1 & 0 \\ - 1 & - 1 & 0 & - 1 & 0 \\ 0 & 0 & 0 & 1 & 0 \\ 0 & 0 & - 1 & 1 & 0 \\ 0 & 0 & 0 & 0 & 0\end{matrix} ] ,$$

appreciated that least square has been used to determine the coefficient values and that L₂ error calculation is used to determine the error. However, use of the same standard for coefficient calculation and error calculation is for illustration purposes and should not be construed as limiting the scope of the embodiments. For example, in some embodiments, even though a least square may be used to determine the coefficient values but nonetheless L₁ error calculation may be used to determine the error. The approximation of color type green in color space is illustrated in FIG. 2D.

Similar to the process above the color type blue may be represented by equation (18) below:

$$b = {a}_{1} * r + {a}_{2} * g + {a}_{3} , \qquad ( 18 )$$

where r is the value for color type red, g is the color value for color type green, b is the color value for color type blue, and a₁, a₂, and a₃ are the coefficients of the approximation function as determined based on the metric 202, which in this instance may be least squares as shown by equation (15) above. In other words, the coefficient values a₁, a₂, and a₃are determined by solving the equation bounded by equation (15). Coefficient values a₁, a₂, and a₃ are determined to be 1.7480, −0.8339, and −37.0865 respectively. Accordingly, the three determined coefficients replace 25 blue color type values in 25 pixels. Using the determined coefficients for the approximation function and rounding to the integer values to estimate color type green results in

$${C}_{n , m , 3} = [ \begin{matrix}78 & 75 & 75 & 78 & 80 \\ 75 & 75 & 75 & 75 & 80 \\ 80 & 80 & 75 & 71 & 75 \\ 84 & 81 & 75 & 74 & 71 \\ 80 & 80 & 80 & 80 & 77\end{matrix} ] .$$

The difference between P_{n,m,3} and C_{n,m,3} with rounding becomes:

$${P}_{n , m , 3} - {C}_{n , m , 3} - [ \begin{matrix}1 & 1 & 1 & - 1 & 0 \\ - 1 & - 1 & 0 & - 1 & 0 \\ 0 & 0 & 0 & 0 & 1 \\ 0 & - 1 & - 1 & 0 & 0 \\ 0 & 0 & 0 & 0 & 2\end{matrix} ] ,$$

13. It is appreciated that least square has been used to determine the coefficient values and that L₂ error calculation is used to determine the error. However, use of the same standard for coefficient calculation and error calculation is for illustration purposes and should not be construed as limiting the scope of the embodiments. For example, in some embodiments, even though a least square may be used to determine the coefficient values but nonetheless L₁ error calculation may be used to determine the error. The approximation of color type green in color space is illustrated in FIG. 2E.

It is appreciated that in some embodiments, the error for each color type has been determined by the error determiner 230 while the coefficients for the approximation function for each color type is determined by the function parameter determiner 220 unit. In some embodiments, the parameter selector 240 may compare the error associated with each and select the coefficients for the color type with the smallest error, in this example color type red. In other words, replacing the color red values for each pixel by the approximation function and its determined coefficients results in the smallest error in comparison to other color types, blue or green. As such, the coefficients of the approximation function for the color type red are selected, i.e. a₁=0.7301, a₂=0.3105, and a₃=18.7356 for the approximation function. It is appreciated that the color type red is therefore replaced with the approximation function and its determined parameters, thereby compressing the color image data. In some optional embodiments, the determined coefficients may be transmitted to the integer and/or entropy compression 250 unit for further modification, e.g., reduced to an integer by multiplying by 1024 and rounding to an integer value that results in modified parameters 252 of a₁′=748, a₂′=318, and a₃′=19185 that are more suitable for storage and transmission.

It is appreciated that the determined selected parameters 242 or the modified parameters 252 and its approximation function are stored for later retrieval or are transmitted to a decompression unit in order to reconstruct and restore the original image from the compressed image, i.e. decompress the compressed image. It is appreciated that in order to restore and reconstruct the original image from the compressed image, the color value for the color type being approximated by the approximation function and its coefficients are determined. In this example, the approximation function and the coefficients as selected above are used to determine the color value for color type red for each pixel. As such, the image is restored and reconstructed from the compressed image with reduced distortion.

As another nonlimiting example, a YUV model example is provided for illustrative purposes. An image or a portion of an image may be received. The image may be a square of 51 by 51 pixels and divided into portions with 5×5 pixels, where each pixel has three color types associated therewith (i.e. Y, U, and V). The color values for the image that is 5×5 may color type Y may be:

$${P}_{n , m , 1} = [ \begin{matrix}150 & 147 & 148 & 111 & 85 \\ 176 & 173 & 171 & 143 & 113 \\ 200 & 204 & 202 & 196 & 189 \\ 203 & 206 & 212 & 216 & 206 \\ 182 & 188 & 198 & 211 & 222\end{matrix} ]$$

The color values for the image that is 5×5 may color type U may be:

$${P}_{n , m , 2} = [ \begin{matrix}147 & 144 & 147 & 111 & 88 \\ 174 & 171 & 172 & 147 & 119 \\ 200 & 204 & 205 & 200 & 197 \\ 200 & 205 & 212 & 218 & 212 \\ 178 & 185 & 195 & 211 & 222\end{matrix} ]$$

The color values for the image that is 5×5 may color type V may be:

$${P}_{n , m , 3} = [ \begin{matrix}135 & 135 & 140 & 101 & 72 \\ 154 & 152 & 154 & 128 & 102 \\ 172 & 176 & 174 & 177 & 179 \\ 176 & 178 & 182 & 192 & 187 \\ 154 & 158 & 166 & 181 & 196\end{matrix} ]$$

It is appreciated that pixel values arranged in color space without any pixel coordinate information is illustrated in FIG. 2F. For this illustrative example, the selected approximation function is equation (7) and as such the function for color type Y may be represented by equation (19) below:

$$Y = {a}_{1} * U + {A}_{2} * V + {a}_{3} , \qquad ( 19 )$$

where Y is the value for color type Y (described above), U is the color value for color type U (described above), V is the color value for color type V (described above), and a₁, a₂, and a₃ are the coefficients of the approximation function as determined based on the metric 202, which in this instance may be least squares as shown by equation (15) above. In other words, the coefficient values a₁, a₂, and a₃ are determined by solving the equation bounded by equation (15). Coefficient values a₁, a₂, and a₃ are determined to be −7.9, −1.7, and 1323.7 respectively.

Accordingly, the three determined coefficients replace 25 Y color type values in 25 pixels. The compression ratio resulting from this is 1−(50+3)/75=0.2933 as determined through equation (3). Using the determined coefficients for the approximation function and rounding to the integer values to estimate color type Y results in

$${C}_{n , m , 1} = [ \begin{matrix}152 & 132 & 123 & 132 & 161 \\ 180 & 180 & 171 & 171 & 161 \\ 209 & 209 & 219 & 190 & 161 \\ 200 & 209 & 219 & 200 & 190 \\ 200 & 209 & 219 & 219 & 219\end{matrix} ] .$$

The difference between P_{n,m,1} and C_{n,m,1} with rounding becomes:

$${P}_{n , m , 1} - {C}_{n , m , 1} = [ \begin{matrix}10 & - 8 & - 19 & 22 & 72 \\ 16 & 18 & 9 & 32 & 46 \\ 24 & 21 & 31 & 6 & - 20 \\ 14 & 19 & 24 & 0 & - 4 \\ 32 & 36 & 38 & 25 & 12\end{matrix} ] ,$$

resulting in an error metric L₁ of 37, and L₂ of 91. It is appreciated that least square has been used to determine the coefficient values and that L₂ error calculation is used to determine the error. However, use of the same standard for coefficient calculation and error calculation is for illustration purposes and should not be construed as limiting the scope of the embodiments. For example, in some embodiments, even though a least square may be used to determine the coefficient values but nonetheless L₁ error calculation may be used to determine the error.

It is appreciated that in some embodiments a similar process may be performed for each color type, i.e. color type U and V. Color type U may be represented by equation (20) below:

$$U = {a}_{1} * Y + {a}_{2} * V + {a}_{3} . \qquad ( 20 )$$

It is appreciated that a₁, a₂, and a₃ coefficients of the approximation function are determined based on the metric 202, which in this instance may be least squares as shown by equation (15) above. In other words, the coefficient values a₁, a₂, and a₃ are determined by solving the equation bounded by equation (15). Coefficient values a₁, a₂, and a₃ are determined to be −0.0751, −0.4349, and 187.2 respectively. Accordingly, the three determined coefficients replace 25 U color type values in 25 pixels. Using the determined coefficients for the approximation function and rounding to the integer values to estimate color type U results in

$${C}_{n , m , 2} = [ \begin{matrix}120 & 120 & 120 & 123 & 125 \\ 118 & 119 & 119 & 121 & 123 \\ 117 & 117 & 117 & 118 & 119 \\ 116 & 116 & 116 & 116 & 117 \\ 118 & 117 & 117 & 116 & 116\end{matrix} ] .$$

The difference between P_{n,m,2} and C_{n,m,2} with rounding becomes:

$${P}_{n , m , 2} - {C}_{n , m , 2} = [ \begin{matrix}- 2 & - 4 & - 5 & - 1 & 4 \\ - 1 & 0 & - 1 & 1 & 2 \\ 1 & 1 & 2 & 0 & - 2 \\ - 1 & 0 & 1 & - 1 & - 1 \\ 1 & 1 & 2 & 1 & 1\end{matrix} ] ,$$

resulting in an error metric L₂ of 37. It is appreciated that least square has been used to determine the coefficient values and that L₂ error calculation is used to determine the error. However, use of the same standard for coefficient calculation and error calculation is for illustration purposes and should not be construed as limiting the scope of the embodiments. For example, in some embodiments, even though a least square may be used to determine the coefficient values but nonetheless L₁ error calculation may be used to determine the error.

Similar to the process above the color type V may be represented by equation (21) below:

$$V = {a}_{1} * Y + {a}_{2} * U + {a}_{3} . \qquad ( 21 )$$

It is appreciated that a₁, a₂, and a₃ coefficients of the approximation function are determined based on the metric 202, which in this instance may be least squares as shown by equation (15) above. In other words, the coefficient values a₁, a₂, and a₃ are determined by solving the equation bounded by equation (15). Coefficient values a₁, a₂, and a₃ are determined to be −0.0075, −0.2034, and 154.6 respectively. Accordingly, the three determined coefficients replace 25 V color type values in 25 pixels. Using the determined coefficients for the approximation function and rounding to the integer values to estimate color type V results in

$${C}_{n , m , 3} = [ \begin{matrix}129 & 128 & 128 & 129 & 129 \\ 129 & 129 & 129 & 129 & 129 \\ 130 & 130 & 130 & 129 & 129 \\ 129 & 130 & 130 & 129 & 129 \\ 130 & 130 & 130 & 130 & 130\end{matrix} ] .$$

The difference between P_{n,m,3} and C_{n,m,3} with rounding becomes:

$${P}_{n , m , 3} - {C}_{n , m , 3} = [ \begin{matrix}- 1 & - 2 & - 1 & 0 & 1 \\ - 1 & - 1 & 0 & 1 & 2 \\ 0 & 0 & 1 & 1 & 3 \\ - 2 & 0 & 0 & 0 & 2 \\ - 1 & - 1 & - 1 & 0 & 2\end{matrix} ] ,$$

resulting in an error metric, L₁ of 22, and L₂ of 38. It is appreciated that least square has been used to determine the coefficient values and that L₂ error calculation is used to determine the error. However, use of the same standard for coefficient calculation and error calculation is for illustration purposes and should not be construed as limiting the scope of the embodiments. For example, in some embodiments, even though a least square may be used to determine the coefficient values but nonetheless L₁ error calculation may be used to determine the error.

It is appreciated that in some embodiments, the error for each color type has been determined by the error determiner 230 while the coefficients for the approximation function for each color type is determined by the function parameter determiner 220 unit. In some embodiments, the parameter selector 240 may compare the error associated with each and select the coefficients for the color type with the smallest error, in this example color type V. In other words, replacing the color type V values for each pixel by the approximation function and its determined coefficients results in the smallest error in comparison to other color types, Y and U. As such, the coefficients of the approximation function for the color type V are selected, i.e. a₁=−0.0075, a₂=−0.2034, and a₃=154.6 for the approximation function. It is appreciated that the color type V is therefore replaced with the approximation function and its determined parameters, thereby compressing the color image data. In some optional embodiments, the determined coefficients may be transmitted to the integer and/or entropy compression 250 unit for further modification, e.g., reduced to an integer by multiplying by 1024 and rounding to an integer value that results in modified parameters 252 of a₁′=−8, a₂′=−208, and a₃′=158298 that are more suitable for storage and transmission.

It is appreciated that the determined selected parameters 242 or the modified parameters 252 and its approximation function are stored for later retrieval or are transmitted to a decompression unit in order to reconstruct and restore the original image from the compressed image, i.e. decompress the compressed image. It is appreciated that in order to restore and reconstruct the original image from the compressed image, the color value for the color type being approximated by the approximation function and its coefficients are determined. In this example, the approximation function and the coefficients as selected above are used to determine the color value for color type red for each pixel. As such, the image is restored and reconstructed from the compressed image with reduced distortion.

It is appreciated that in the examples above for RGB and YUV model, the coefficients for a given approximation function is calculated for each color type and the best coefficients that result in smallest error or closest approximation to the actual color value are selected. However, in some embodiments, an approximation function may be selected and coefficients may be determined for a color type (or transformation thereof) without comparing its associated error with errors associated with other color types. In the example above, once the approximation function is selected and coefficients of the approximation function for a color type, e.g., blue in this instance, may be determined and used regardless of whether its error (similarity between the approximation to actual color) is smaller or larger in comparison to coefficients determined based on other color types.

It is appreciated that other compression techniques may be performed on color types that are not being approximated. For example, if the color type blue is being approximated then other compression techniques, e.g., wavelets, quantization, subdiscretization, entropic, etc., may also be performed on color type red and/or green.

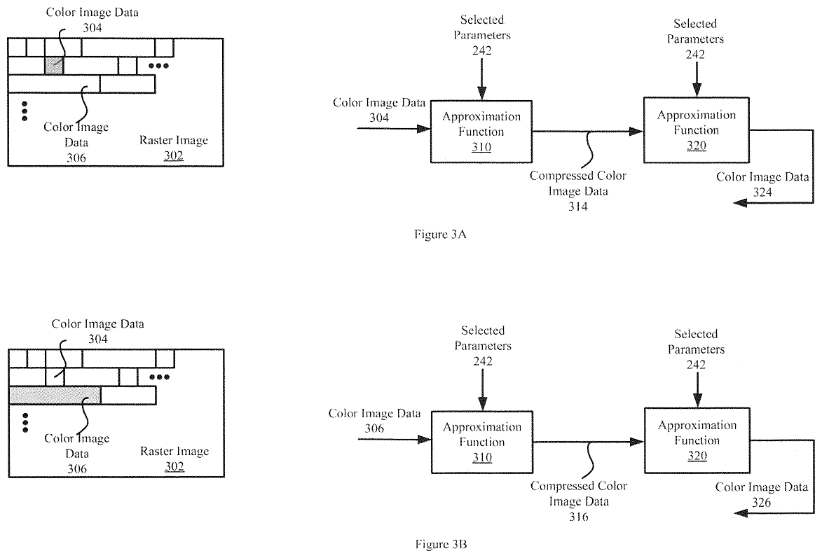

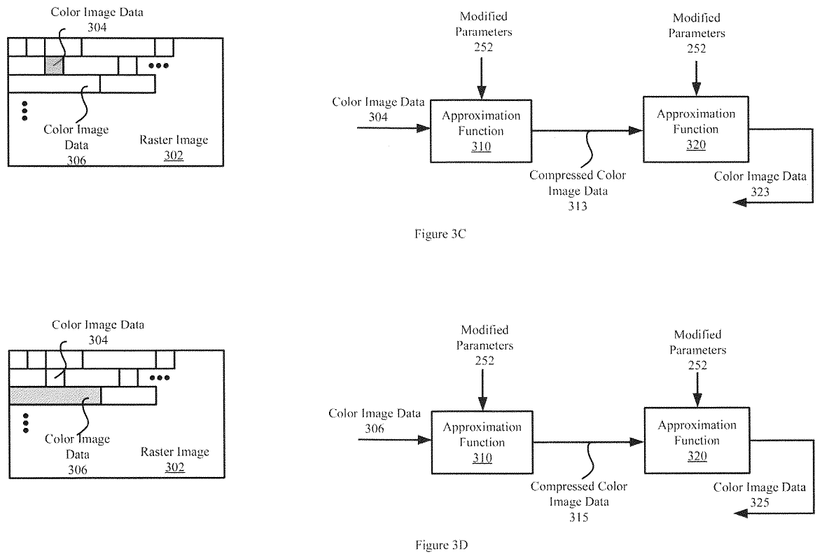

Referring now to FIGS. 3A-3D, image compression/decompression in accordance with some embodiments is depicted. In some embodiments, a raster image 302 (also referred to as digital image or colored image) is received. The raster image 302 may be divided into a plurality of segments, e.g., color image data 304, . . . , color image data 306. A color image data, e.g., color image data 304, may be transmitted to the approximation function 310 where the approximation function has been selected (as described above). As described above, the parameters associated with the approximation function is also determined (i.e. coefficients as described above) and received as the selected parameters 242. The color image data 304 is therefore compressed using the approximation function and its selected parameters 242. In other words, one color type, e.g., color type red, in the color image data 304 is replaced with the approximation function and its coefficients. As such, instead of each pixel with the color type red having a value, only one approximation function and its coefficients are used, thereby compressing the color image data 304 to form a compressed color image data 314. The compressed color image data 314 may be stored for later retrieval or it may be transmitted to a decompression unit to restore and recovery the original image. In this example, the compressed color image data 314 is received by the approximation function 320 that uses the approximation function with the selected parameters 242 to approximate the color value for color type red for each pixel, thereby generating an approximated image or color image data 324. It is appreciated that the color image data 324 is the approximation of the original color image data 304.

Referring now to FIG. 3B, the process as described in FIG. 3A is repeated for other color image data of the raster image 302. For example, a similar process may be performed for color image data 306 in order to compress it (i.e. forming compressed color image data 316) and ultimately to restore the original image (i.e. color image data 306) by approximation as color image data 326. It is appreciated that in some embodiments, the same approximation function and coefficients/parameters may be used for each segment of the image. In other words, the approximation function and its coefficients used for the color image data 304 and 306 may be the same. However, it is appreciated that in some other embodiments, the approximation function and/or the coefficients for each segment may be determined separately and be different. For example, the approximation function and/or coefficients used to compress the color image data 304 and ultimately decompress to restore color image data 324 may be different from that of color image 306. In other words, the process of selecting the approximation function and its coefficients for each segment of the raster image 302 may be independent from one another and as such use the same or different approximation function and the same or different coefficients.

FIGS. 3C and 3D are similar to that of FIGS. 3A and 3B respectively, however, instead of using the parameters 242 the modified parameters 252 are used, e.g., quantized, rounded, etc. In FIG. 3C, a compressed color image data 313 is formed by using the modified parameters 252 for the selected approximation function and ultimately the color image data 323 that is approximation of the color image data 304 is produced. In comparison, the compressed color image data 315 is formed by using the modified parameters 252 for the selected approximation function and ultimately the color image data 325 that is approximation of the color image 306 is produced.

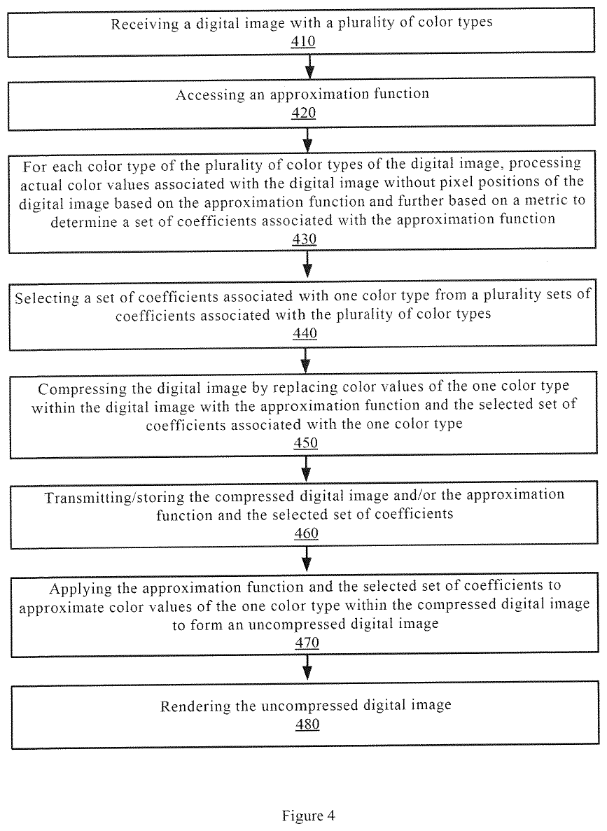

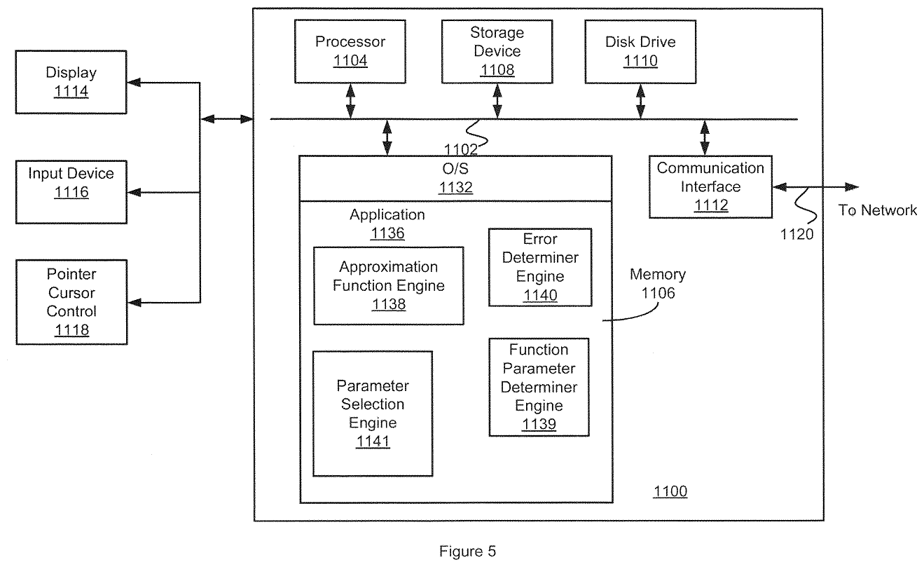

FIG. 4 depicts a flow chart illustrating an example of method flow for compressing/decompressing a digital image in accordance with some embodiments. At step 410, a digital image with a plurality of color types is received, wherein the digital image is to be compressed, as described above with respect to FIGS. 1A-3D. At step 420, an approximation function is accessed, as described above. It is appreciated that in some optional embodiments the approximation may be user selectable. The approximation function approximates a color value of a color type of the plurality of color types based on at least two or more other color types of the plurality of color types. It is appreciated that the approximation is independent of pixel positions of the digital image. At step 430, for each color type of the plurality of color types of the digital image, actual color values associated with the digital image without pixel positions of the digital image is processed based on the approximation function and further based on a metric to determine a set of coefficients associated with the approximation function, as described above. It is appreciated that the metric may be user selectable in some optional embodiment or it may be selected by the system automatically. It is appreciated that the metric determines a similarity between approximated color values and the actual color values of the digital image. At step 440, a set of coefficients associated with one color type from a plurality sets of coefficients associated with the plurality of color types is selected. Accordingly, at step 450, the digital image is compressed by replacing color values of the one color type within the digital image with the approximation function and the selected set of coefficients associated with the one color type. At step 460, the compressed image and/or the approximated function and/or its selected set of coefficients may transmitted/stored.

As described above, the plurality of color types may be Y, U, or V in the YUV model, may be R, G, or B in RGB model, may be C, M, Y, or K in CMYK model, etc. It is appreciated that the approximation function may be a plane function, a hyperplane function, a bilinear function, a quadratic function, an exponential function, a cosine function, a piecewise function, or a spline function. In some examples, the metric may be a PSNR or SSIM or MSE or LSM. It is appreciated that in some optional embodiments, the selected coefficients may be quantized, rounded, scaled, or coded. It is also appreciated that in some optional embodiments, other types of compression techniques may be performed on other color types that are not being approximated. For example, if the value of color type red is being approximated then the color types blue and/or green may be compressed using other types of compression techniques, e.g., wavelets, quantization, subdiscretization, entropic, etc.

In some embodiments, at step 470, the approximation function and its coefficients may be used to restore (i.e. approximate) the color values for a color type in the compressed digital image to form an uncompressed digital image. At step 480, the uncompressed (i.e. approximated image) may be rendered and displayed.

FIG. 5 depicts a block diagram depicting an example of computer system suitable for compressing an image in accordance with some embodiments. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as static storage device 1108 or disk drive 1110. In some examples, hard-wired circuitry can be used in place of or in combination with software instructions for implementation. In the example shown, system memory 1106 includes modules of executable instructions for implementing an operating system (“OS”) 1132, an application 1136 (e.g., a host, server, web services-based, distributed (i.e., enterprise) application programming interface (“API”). program, procedure or others). Further, application 1136 includes a module of executable instructions for approximation function engine 1138 that determines/selects the approximation function and uses it to compress/decompress images, function parameter determiner engine 1139 that uses the color types of an image to determine the parameters (i.e. coefficients) for the approximation function, error determiner engine 1140 that determines the error associated with each color type (or transformation), and parameter selection engine 1141 that selects a set of coefficients to be used for the selected approximation function to compress digital image and subsequently decompress the compressed images.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex.™., Fireworks.®., Java.™., Javascript.™., AJAX, COBOL, Fortran, ADA, XML, HTML, DHTML, XHTML, HTTP, XMPP, and others. These can be varied and are not limited to the examples or descriptions provided.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A computer-implemented method for compressing a digital image, the method being performed by one or more computer systems and comprising:
receiving a digital image with a plurality of color types, wherein the digital image is to be compressed;
accessing an approximation function, wherein the approximation function approximates a color value of a color type of the plurality of color types based on at least two or more other color types of the plurality of color types, wherein the approximation is independent of pixel positions of the digital image;
for each color type of the plurality of color types of the digital image, processing actual color values associated with the digital image without pixel positions of the digital image based on the approximation function and further based on a metric to determine a set of coefficients associated with the approximation function, wherein the metric determines a similarity between approximated color values and the actual color values of the digital image;
selecting a set of coefficients associated with one color type from a plurality sets of coefficients associated with the plurality of color types;
compressing the digital image by replacing color values of the one color type within the digital image with the approximation function and the selected set of coefficients associated with the one color type; and
transmitting and/or storing the compressed digital image.

2. The method of claim 1, wherein the plurality of color types is either a first group including red, green, and blue, or a second group including YUV model wherein Y is brightness, and wherein U and V are color differences, or a third group including Cyan, Magenta, Yellow, and Key (CMYK) model.

3. The method of claim 1, wherein the approximation function is either a plane function, a hyperplane function, a bilinear function, a quadratic function, an exponential function, a cosine function, a piecewise function, or a spline function.

4. The method of claim 1, wherein the metric is either a peak signal-to-noise ratio (PSNR) or a structural similarity index measure (SSIM) or mean square error (MSE) or least square mean (LSM).

5. (canceled)

6. The method of claim 1 further comprising storing the approximation function and the selected set of coefficients.

7. The method of claim 1 further comprising:
accessing the approximation function and the selected set of coefficients;
receiving the compressed digital image; and
applying the approximation function and the selected set of coefficients to approximate color values of the one color type within the compressed digital image to form an uncompressed digital image.

8. The method of claim 7 further comprising rendering the uncompressed digital image.

9. The method of claim 1 further comprising performing one or more of quantizing the selected set of coefficients, rounding the selected set of coefficients, scaling the selected set of coefficients, and coding the selected set of coefficients.

10. The method of claim 1 further comprising performing compression on color types other than the one color type.

11. The method of claim 10, wherein the compression is selected from a group consisting of wavelets, quantization, subdiscretization, and entropic.

12. The method of claim 1 further comprising selecting the approximation function.

13. The method of claim 1 further comprising selecting the metric.

14. A computer-implemented method for compressing a portion of a digital image, the method being performed by one or more computer systems and comprising:
receiving a digital image with a plurality of color types, wherein the digital image is to be compressed;
dividing the digital image into a plurality of portions;
accessing an approximation function, wherein the approximation function approximates a color value of a color type of the plurality of color types within a portion from the plurality of portions based on at least two or more other color types of the plurality of color types within the portion from the plurality of portions, wherein the approximation is independent of pixel positions of the digital image;
for each color type of the plurality of color types of the portion of the digital image, processing actual color values associated with the portion of the digital image without pixel positions of the portion of the digital image based on the approximation function and further based on a metric to determine a set of coefficients associated with the approximation function, wherein the metric determines a similarity between approximated color values and the actual color values of the portion of the digital image;
selecting a set of coefficients associated with one color type from a plurality sets of coefficients associated with the plurality of color types for the portion of the plurality of portions of the digital image; and
compressing the portion of the digital image by replacing color values of the one color type within the portion of the digital image with the approximation function and the selected set of coefficients associated with the one color type.

15. The method of claim 14 further comprising repeating the accessing, the processing, the selecting, and the compressing for a different portion of the plurality of portions of the digital image.

16. The method of claim 15, wherein the approximation function of the portion of the digital image is different from an approximation function of the different portion of the plurality of the portions of the digital image.

17. The method of claim 15 further comprising transmitting and storing compressed portions of the digital image.

18. The method of claim 14, wherein the plurality of color types is either a first group including red, green, and blue, or a second group including YUV model wherein Y is brightness, and wherein U and V are color differences, or a third group including Cyan, Magenta, Yellow, and Key (CMYK) model.

19. The method of claim 14, wherein the approximation function is either a plane function, a hyperplane function, a bilinear function, a quadratic function, an exponential function, a cosine function, a piecewise function, or a spline function.

20. The method of claim 14, wherein the metric is either a peak signal-to-noise ratio (PSNR) or a structural similarity index measure (SSIM) or mean square error (MSE) or least square mean (LSM).

21. A computer-implemented method for compressing a digital image, the method being performed by one or more computer systems and comprising:
receiving a digital image with a plurality of color types, wherein the digital image is to be compressed;
receiving an approximation function and coefficients associated therewith, wherein the approximation function approximates a color value of a one color type of the plurality of color types based on at least two or more other color types of the plurality of color types, wherein the approximation is independent of pixel positions of the digital image;
compressing the digital image by replacing color values of the one color type within the digital image with the approximation function and the selected set of coefficients associated with the one color type; and
transmitting and/or storing the compressed digital image.
